(19) United States
(12) Patent Application Publication
(10) Pub. No.: US 2020/0080509 A1
(43) Pub. Date: Mar. 12, 2020

(54) Weight-Optimized Steel Piston

(71) Applicant: KS Kolbenschmidt GmbH, Neckarsulm (DE)

(72) Inventors: Albert Haberl, Bad Friedrichshall (DE); Thorsten Thomassen, Erlenbach (DE)

(21) Appl. No.: 16/466,771

(22) PCT Filed: Dec. 6, 2017
(86) PCT No.: PCT/EP2017/081725

§ 371 Date: Jun. 5, 2019

(30) Foreign Application Priority Data
Dec. 6, 2016 (DE) 10 2016 123 573.3

(51) Int. Cl. F02F 3/00; F16J 1/00

(52) U.S. Cl. CPC F02F 3/0076; F16J 1/005

(57) ABSTRACT

The invention relates to a piston of an internal combustion engine, having an upper part with appended piston bosses and load-bearing skirt wall sections, wherein the load-bearing skirt wall sections are arranged in a self-supporting manner on the upper part without any attachment to the piston bosses, and wherein a rib extends from the underside of the upper part in the direction of the inner side of the load-bearing skirt wall sections.

### TECHNICAL FIELD

The invention relates to a piston of an internal combustion engine. In one example, the piston includes an upper part with piston bosses appended thereon and with load-bearing skirt wall sections.

### BACKGROUND

Pistons for internal combustion engines have either a cylindrical, fully circumferential piston skirt, which is arranged (appended) beneath an upper part of the piston, or pistons exist in the so-called box design, wherein such pistons have load-bearing skirt wall sections, so that the piston skirt thereof is only partially present and is not configured so as to be fully cylindrical. In their self-supporting marginal areas, the load-bearing skirt wall sections are connected, via connecting walls which extend in the direction of the piston bosses. Hereby, a necessary supporting of the load-bearing skirt wall sections is achieved during the operation of the piston in the cylinder of the internal combustion engine. For this, it is necessary that the connecting walls extend, proceeding from each pin boss, in the direction of the lateral regions of the load-bearing skirt wall sections. Through this in total quadruple embodiment of the connecting walls, the material of the piston increases, in order to achieve the necessary supporting of the load-bearing skirt wall sections on the upper part. An example of such a box design of a piston is known from DE 101 45 589. With this design of the known piston, namely with simultaneous weight reduction, the necessary skirt wall rigidity is achieved with, at the same time, necessary resilience of the load-bearing skirt wall sections. However, such a piston is not yet satisfactory with regard to its weight.

### SUMMARY

The invention is therefore based on the problem of providing a piston of an internal combustion engine with which the disadvantages which were described in the introduction are avoided and which is further optimized with regard to its weight, in particular with regard to a weight reduction.

In accordance with the invention, provision is made that the load-bearing skirt wall sections are arranged in a self-supporting manner on the upper part without a connection to the piston bosses, and that proceeding from the underside of the upper part a rib runs in the direction of the inner side of the load-bearing skirt wall sections. According to the invention, the known connecting walls, which are present between the pin bosses and the lateral edges of the load-bearing skirt wall sections, are therefore replaced by only one rib, which presents a connection between the upper part of the piston, in particular the underside of the upper part, and the inner side of the load-bearing skirt wall sections. Thereby, the weight of the piston is distinctly reduced and, at the same time, the connection of the load-bearing skirt wall sections to the upper part is realized. The configuration of the rib, in particular its course, its shape and its thickness is to be selected depending on the supporting of the load-bearing skirt wall sections and therefore so that for the respective purpose of use of the piston in the internal combustion engine, on the one hand, the necessary supporting of the load-bearing skirt wall sections takes place and, on the other hand, the necessary resilience of the load-bearing skirt wall sections is provided during the movement of the piston in the cylinder of the internal combustion engine.

The piston according to the invention can be produced according to the conventional known production methods, for example in a casting method, wherein however forging methods are also conceivable. In a particularly advantageous manner, the piston is produced in one piece with the load-bearing skirt wall sections arranged in a self-supporting manner on the upper part, with the pin bosses and with the upper part according to one of the mentioned methods. It is also conceivable to produce the individual elements (such as skirt wall sections, pin bosses, upper part and suchlike) as individual parts and to connect these to one another non-detachably by a joining method. In particular, it can be considered to produce the upper part in one piece with the appended piston bosses in a suitable method and to produce the rib and the load-bearing skirt wall sections separately therefrom, which are thereafter joined by means of a suitable joining method on the prepared upper part of the piston with its pin bosses.

The course of the rib is basically variable in height in a manner adapted to the load requirements, preferably running maximally up to the lower piston end.

In further development of the invention, the rib runs up to the lower edge of the load-bearing skirt wall sections. Whilst it is basically conceivable not to direct the rib up to the lower edge and to allow it to run out in the course of the rising skirt wall sections (in relation to the piston stroke axis), the course of the rib up to the lower edge of the skirt wall sections is particularly advantageous, in order to realize the necessary arrangement and supporting of the load-bearing skirt wall sections on the upper part of the piston.

In further development of the invention, the rib runs centrally in the inner region of the piston. This means that the rib runs through the piston stroke axis. This has the advantage that thereby the piston can be configured mirror-symmetrically and thereby the applied method of production can be simplified.

In further development of the invention, the load-bearing skirt wall sections are configured in a fully self-supporting manner and are connected only via the rib on the upper part. Whilst it is basically conceivable that the load-bearing skirt wall sections are arranged and connected directly on the underside of the upper part, it is also conceivable to configure the load-bearing skirt wall sections in a fully self-supporting manner and to connect them only via the rib on the upper part, in particular its underside. Such an embodiment presents itself when the upper part with its appended pin bosses, and if applicable also the rib, are produced in one piece in a suitable method and the load-bearing skirt wall sections are realized separately therefrom. When this is carried out, the load-bearing skirt wall sections are joined as individual parts on the rib without connection, in particular without joining connection, onto the underside of the upper part only on the rib. Thereby, the weight of the piston can be further reduced, because the area of the load-bearing skirt wall sections must be configured to be only as large as is necessary for the supporting of the piston in the cylinder of the internal combustion engine.

In further development of the invention, the load-bearing skirt wall sections have an indentation. Through such an indentation, the weight of the piston can likewise be reduced, without the area which is necessary for the supporting of the piston in the cylinder of the internal combustion engine being reduced in a disadvantageous manner. In a particularly advantageous manner, the indentation runs parallel to the piston stroke axis, wherein, however, other orientations are also conceivable.

### BRIEF DESCRIPTION OF THE DRAWINGS

Example embodiments of a piston according to the invention are described below and explained with the aid of the figures.

FIG. 1 is a bottom perspective view of one example of the piston invention.

FIG. 2 is a top perspective view of the piston in FIG. 1.

FIG. 3 is a cross-sectional view taken along line 3-3 in FIG. 2.

FIG. 4 is a cross-sectional view taken along line 44 in FIG. 2.

FIG. 5 is a bottom perspective view of an alternate example of the piston invention.

FIG. 5A is a cross-sectional view taken along line 5-5 in FIG. 5.

FIG. 6 is a top perspective view of an alternate example of the piston invention.

FIG. 6A is a cross-sectional view taken along line 6-6 in FIG. 6

FIG. 7 is a cross-sectional view taken along line 7-7 in FIG. 6

FIG. 8 is a top perspective view of an alternate example of the piston invention.

FIG. 9 is a cross-sectional view taken along line 9-9 in FIG. 8.

FIG. 10 is a cross-sectional view taken along line 10-10 in FIG. 8.

### DETAILED DESCRIPTION

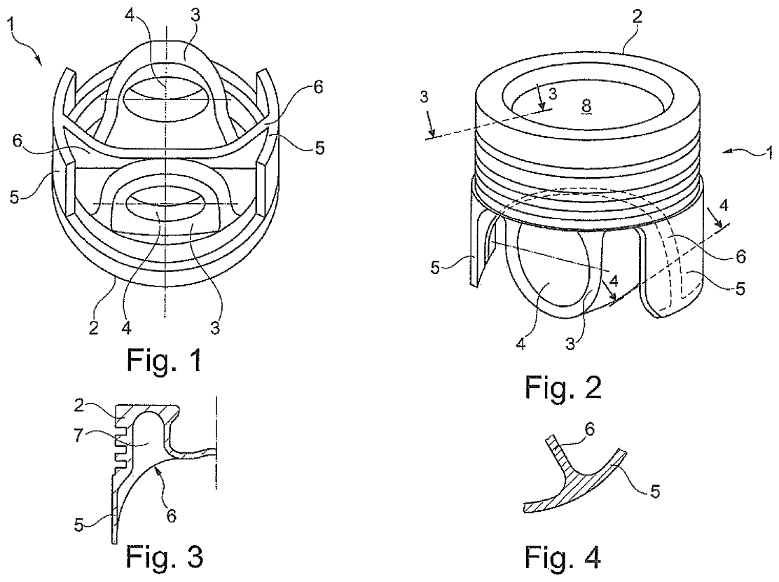

In FIGS. 1 to 4 a first example embodiment of a piston 1 of an internal combustion engine is shown. The piston 1 has an upper part 2 with piston bosses 3 appended thereon, in which piston bosses respectively a pin bore 4 is situated, and load-bearing skirt wall sections 5. In this example embodiment, the load-bearing skirt wall sections 5 are arranged on three sides in a self-supporting manner on the upper part 2, wherein the fourth side has a direct connection (in one piece or joined on) to the upper part 2, in particular its underside. The load-bearing skirt wall sections 5 are supported by a rib 6 running in the direction of the inner side of the load-bearing skirt wall sections 5 proceeding from the underside of the upper part 2. This rib 6 is configured centrally symmetrically and runs through the piston stroke axis.

The piston 1 shown in FIGS. 1 to 4 can have a cooling duct 7, as well as a combustion bowl 8, but it does not have to. When a cooling duct 7 is present, the latter is closed on its underside in a manner known per se, and has an inlet opening and an outlet opening, in order to introduce a cooling medium into the cooling duct 7, to circulate it there and to discharge it again from the cooling duct 7. For the case where the cooling duct 7 is interrupted by the rib 6, it is conceivable that two cooling duct parts, in particular cooling duct halves, are configured, or that a transfer opening is provided in the rib 6.

The cooling duct 7 illustrated in particular in FIG. 3 does not necessarily have to serve as a cooling duct, but can also simply be present as a free space for the further weight reduction in the upper part 2.

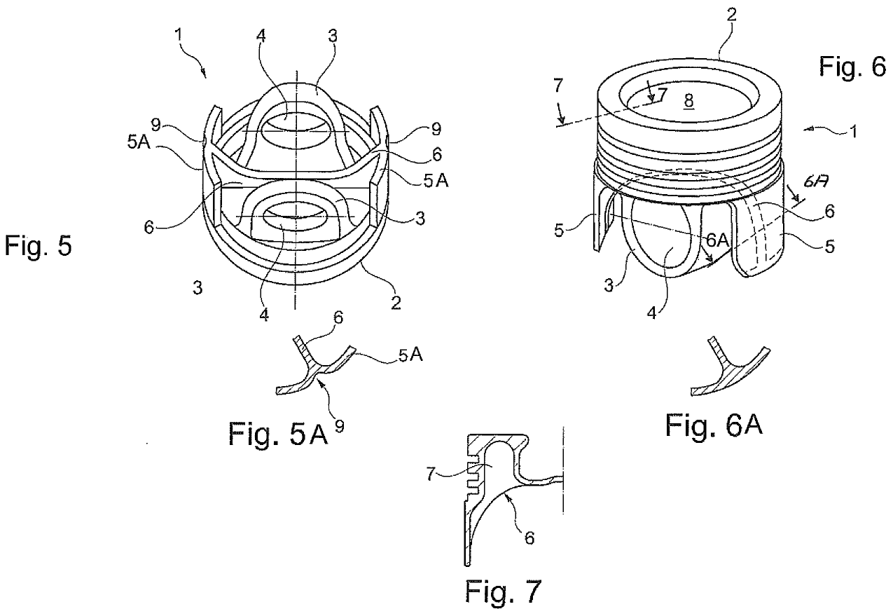

FIGS. 5 to 7 show similar examples of the embodiment of a piston 1, wherein the same elements are given the same reference numbers in these figures as already in FIGS. 1 to 4.

Referring to FIGS. 5, and 5A, it is illustrated in particular that the load-bearing skirt wall sections 5A have an indentation 9. This indentation 9 runs parallel to the piston stroke axis, but can also have a different orientation.

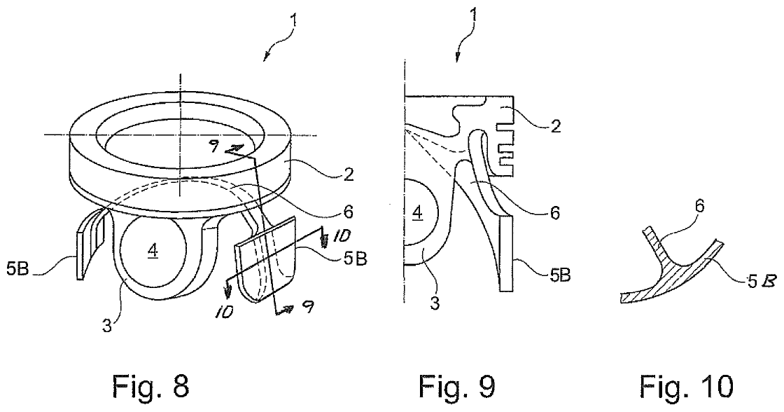

Whilst in the preceding figures it has been illustrated and described that the load-bearing skirt wall sections 5, 5A are arranged with three sides in a self-supporting manner on the upper part 2 via the fourth side, it is illustrated in FIGS. 8 to 10 that the load-bearing skirt wall sections 5B are arranged in a fully self-supporting manner only via the rib 6 on the underside of the upper part 2. This means that the load-bearing skirt wall sections 5B have four free sides and are only connected via their inner side and the course of the rib 6 with the upper part 2, in particular on its underside. This configuration presents itself in particular when not only is the weight of the piston 1 to be further reduced, but also for example the upper part 2 and the rib 6 are produced in one piece in a suitable method and the load-bearing skirt wall sections 5B are produced as separate components therefrom and subsequently the load-bearing skirt wall sections 5B are to be arranged and fastened in a non-detachable manner via a suitable method (such as e.g. welding, soldering, gluing or suchlike) on the rib 6.

### REFERENCE LIST

1. piston
2. upper part
3. piston boss
4. pin bore
5. load-bearing skirt wall section
6. rib
7. cooling duct
8. combustion bowl
9. indentation

1. A piston of an internal combustion engine, having an upper part with piston bosses appended thereon and with load-bearing skirt wall sections, characterized in that the load-bearing skirt wall sections are arranged in a self-supporting manner on the upper part without a connection to the piston bosses, and that proceeding from the underside of the upper part a rib runs in the direction of and connects to a respective inner side of the load-bearing skirt wall sections.

2. The piston of claim 1, characterized in that the rib runs up to a lower edge of the respective load-bearing skirt wall sections.

3. The piston of claim 1, characterized in that the rib runs centrally in an inner region of the piston.

4. The piston of claim 1, characterized in that the load-bearing skirt wall sections are configured in a fully self-supporting manner and are connected only via the rib on to the upper part.

5. The piston of claim 1, characterized in that the load-bearing skirt wall sections respectively define an indentation.

6. The piston of claim 5, characterized in that the respective indentation of the load-bearing skirt wall sections is oriented parallel to a piston stroke axis.

7. The piston of claim 2, characterized in that the rib runs centrally in an inner region of the piston.

8. The piston of claim 3, characterized in that the load-bearing skirt wall sections are configured in a fully self-supporting manner and are connected only via the rib to the upper part.

9. The piston of claim 3, characterized in that the load-bearing skirt wall sections respectively define an indentation oriented parallel to a piston stroke axis.

10. An internal combustion engine piston comprising:
an upper part having an underside transverse to a piston stroke axis;
a pair of pin bosses connected to the upper part underside, the pin bosses extending downward from the upper part underside parallel to the piston stroke axis;
a pair of load-bearing skirts each having a top wall and a bottom wall defining a skirt height, the pair of skirts oriented diametrically opposite relative to the upper part and extending downward from the upper part underside parallel to the piston stroke axis; and
a rib having an upper wall and a bottom wall defining a rib height, the rib upper wall connected to the upper part underside and extending downward parallel to the piston stroke axis, the rib further extending radially through a central region of the piston, the rib connected to each of the pair of skirts without direct connection of the pair of skirts to the pin bosses.

11. The piston of claim 10 wherein the piston central region comprises the piston stroke axis.

12. The piston of claim 11 wherein each skirt is directly connected to the upper part underside at the skirt top wall.

13. The piston of claim 12 wherein the rib height increases as the rib extends radially outward from the piston stroke axis toward each skirt.

14. The piston of claim 13 wherein the rib bottom wall comprises an arcuate shape between the pair of skirts.

15. The piston of claim 12 wherein the rib is engaged with each skirt along the full height of the respective skirt.

16. The piston of claim 10 wherein each load-bearing skirt defines an indentation oriented parallel to the piston stroke axis.
